(19) United States
(12) Patent Application Publication
(10) Pub. No.: US 2017/0185246 A1
(43) Pub. Date: Jun. 29, 2017

(54) IMAGE DISPLAY APPARATUS AND METHOD OF DISPLAYING IMAGE

(71) Applicant: SAMSUNG ELECTRONICS CO., LTD., Suwon-si (KR)

(72) Inventors: Sung-hyuk KWON, Suwon-si (KR); Jeong-hye CHOI, Seoul (KR)

(73) Assignee: SAMSUNG ELECTRONICS CO., LTD., Suwon-si (KR)

(21) Appl. No.: 15/277,101

(22) Filed: Sep. 27, 2016

(30) Foreign Application Priority Data
Dec. 24, 2015 (KR) 10-2015-0186776

(51) Int. Cl. G06F 3/0482; G06F 3/0488; G06F 3/0481

(52) U.S. Cl. CPC G06F 3/0482; G06F 3/04817; G06F 3/04883

(57) ABSTRACT

Provided are an image display apparatus and a method of displaying an image. The image display apparatus may include a display that displays a plurality of items and displays an item selected from among the plurality of items with a highlight, a detector that detects a user input for moving the highlight, and a controller that, in response to the user input, determines candidate items to which the highlight is to be moved, selects one of the candidate items based on distances between a reference coordinate and the candidate items, and moves the highlight to the selected item.

### CROSS-REFERENCE TO RELATED APPLICATION

This application claims the benefit of Korean Patent Application No. 10-2015-0186776, filed on Dec. 24, 2015, in the Korean Intellectual Property Office, the disclosure of which is incorporated herein in its entirety by reference.

### BACKGROUND

1. Field

The present disclosure relates to an image display apparatus and a method of displaying an image, and more particularly, to an image display apparatus and a method of displaying an image, capable of moving a highlight in a direction corresponding to a user input.

2. Description of the Related Art

An image display apparatus is an apparatus capable of displaying an image that may be viewed by a user. A user may watch a broadcast via an image display apparatus. An image display apparatus displays broadcast content selected by a user from among broadcasts transmitted by broadcasting stations. Currently, broadcasting is being switched from analog broadcasting to digital broadcasting worldwide.

A digital broadcasting service refers to a broadcasting service that transmits digital images and digital voice signals. Since a digital broadcasting service is more resistant to external noise than an analog broadcasting service, a digital broadcasting service exhibits less data loss, easier error correction, high resolutions, and clear images. Also, unlike an analog broadcasting service, a digital broadcasting service may be a bidirectional service.

Furthermore, a smart television (TV) that provides not only a digital broadcasting service but also various other content has recently become available. A smart TV may analyze a user's demands and provide corresponding services without the user's manipulation instead of passively operating based on selections by the user.

### SUMMARY

According to an aspect of an exemplary embodiment, an image display apparatus includes a display that displays a plurality of items and displays an item selected from among the plurality of items with a highlight, a detector that detects a user input for moving the highlight, and a controller that, in response to the user input, determines candidate items for moving the highlight to, selects one of the candidate items based on distances between a reference coordinate and the candidate items, and moves the highlight to the selected item.

The reference coordinate may be determined based on location of a first item from which the highlight starts to move in a direction identical to a current moving direction of the highlight.

The reference coordinate may be a coordinate in a direction perpendicular to the moving direction of the highlight from among coordinates of the first item.

The controller may select an item corresponding to the smallest difference between coordinates of the candidate items in the direction perpendicular to the moving direction of the highlight and the reference coordinate.

When distances between the reference coordinate and the candidate items are identical to one another, the controller may select a leftmost item or a topmost item from among the candidate items.

The candidate items may be items adjacent to the item currently being displayed with the highlight in a current moving direction of the highlight.

As a direction corresponding to the user input is changed to a direction perpendicular to the current moving direction of the highlight, the controller may update the reference coordinate based on coordinates of the item currently being displayed with the highlight.

The controller may update the reference coordinate with a coordinate in a direction perpendicular to the direction corresponding to the user input from among coordinates of the item currently being displayed with the highlight.

The display may display the plurality of items in a 2-dimensional (2D) grid.

The detector may detect a user input for moving the highlight in any one of directions including up, down, left, and right.

According to an aspect of another exemplary embodiment, a method of displaying an image, the method includes displaying a plurality of items and displaying an item selected from among the plurality of items with a highlight, detecting a user input for moving the highlight, determining candidate items to which the highlight is to be moved, in response to the user input, selecting one of the candidate items based on distances between a reference coordinate and the candidate items, and moving the highlight to the selected item.

The reference coordinate may be determined based on location of a first item from which the highlight starts to move in a direction identical to a current moving direction of the highlight.

The reference coordinate may be a coordinate in a direction perpendicular to the moving direction of the highlight from among coordinates of the first item.

The selecting of one of the candidate items may include selecting an item corresponding to the smallest difference between coordinates of the candidate items in the direction perpendicular to the moving direction of the highlight and the reference coordinate.

The selecting of one of the candidate items may further include, when distances between the reference coordinate and the candidate items are identical to one another, selecting the leftmost item or the topmost item from among the candidate items.

The candidate items may be items adjacent to the item currently being displayed with the highlight in a current moving direction of the highlight.

The method may further include, as a direction corresponding to the user input is changed to a direction perpendicular to the current moving direction of the highlight, updating the reference coordinate based on coordinates of the item currently being displayed with the highlight, wherein the updated reference coordinate may be a coordinate of the item currently being displayed with the highlight in a direction perpendicular to the direction corresponding to the user input from among coordinates of the item currently being displayed with the highlight.

The displaying of the plurality of items may include displaying the plurality of items in a 2-dimensional (2D) grid.

The detecting of the user input may include detecting a user input for moving the highlight in any one of directions including up, down, left, and right.

### BRIEF DESCRIPTION OF THE DRAWINGS

These and/or other aspects will become apparent and more readily appreciated from the following description of the exemplary embodiments, taken in conjunction with the accompanying drawings in which:

FIGS. 1A through 1C are diagrams showing an image display apparatus to which a method of displaying an image may be applied, according to an exemplary embodiment;

FIG. 2 is a diagram showing an example of moving a highlight based on information regarding an item on which the highlight is currently located;

FIG. 3 is a flowchart of a method of displaying an image, according to an exemplary embodiment;

FIGS. 4A through 5B are diagrams showing a method of displaying an image according to an exemplary embodiment;

FIG. 6 is a diagram for describing a method of indicating coordinates of an item on an image display apparatus, according to an exemplary embodiment;

FIGS. 7A and 7B are diagrams for describing a case where a direction of a user input is changed in an image display apparatus, according to an exemplary embodiment;

FIG. 8 is a diagram showing an example of a method of displaying an image, according to an exemplary embodiment;

FIG. 9 is a block diagram showing a configuration of the image display apparatus according to an exemplary embodiment;

FIG. 10 is a block diagram showing a configuration of an image display apparatus according to another exemplary embodiment.

### DETAILED DESCRIPTION

Terminologies used in the present specification will be briefly described, and then the detailed description of the inventive concept will be given.

Although the terms used in the inventive concept are selected from generally known and used terms, some of the terms mentioned in the description of the inventive concept have been selected by the applicant at his or her discretion, the detailed meanings of which are described in relevant parts of the description herein. Furthermore, it is required that the inventive concept is understood, not simply by the actual terms used but by the meaning of each term lying within.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

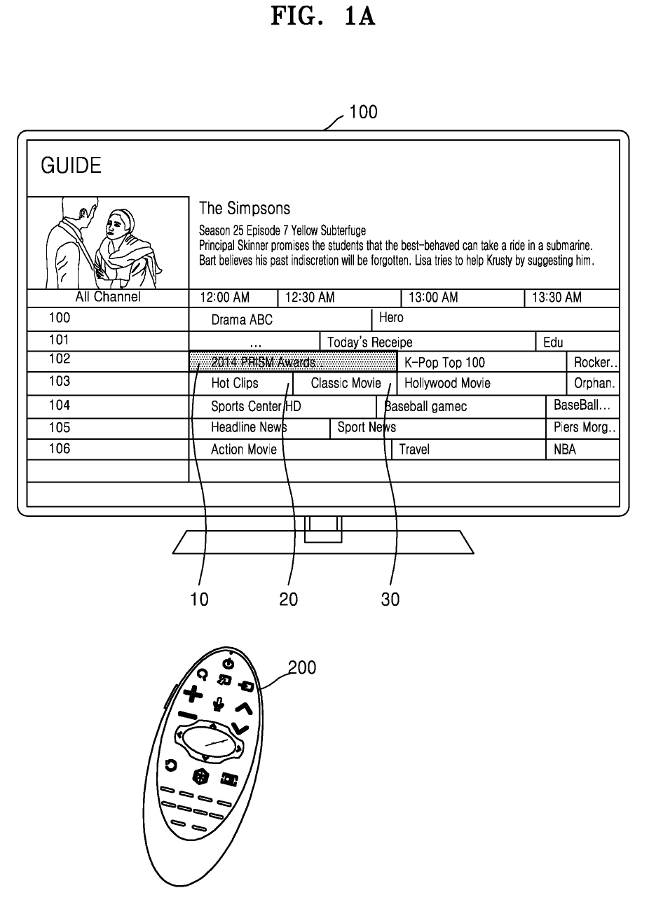

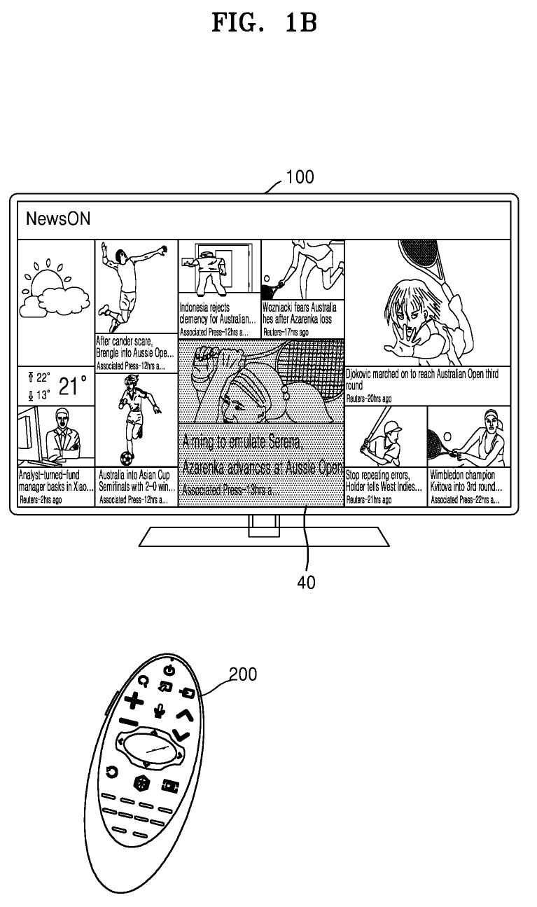

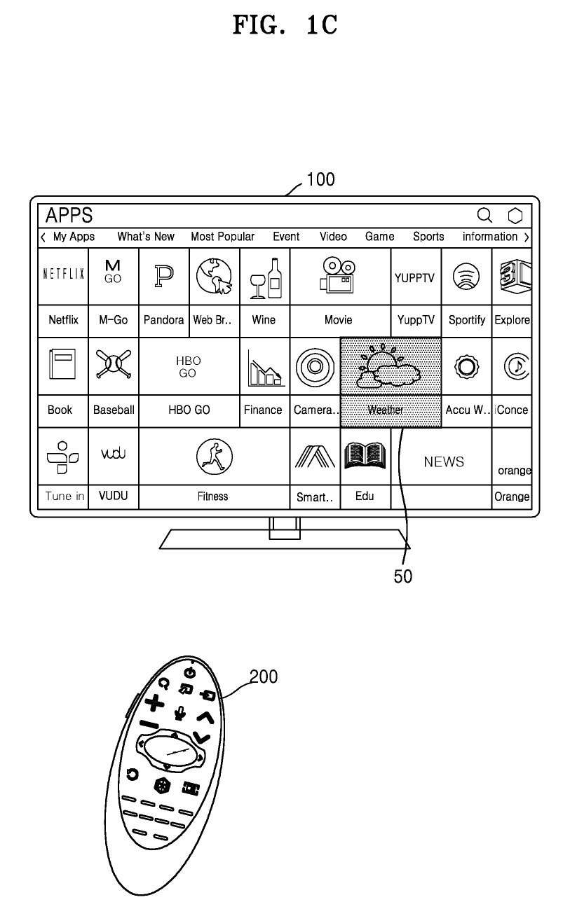

FIGS. 1A through 1C are diagrams showing an image display apparatus to which a method of displaying an image may be applied, according to an exemplary embodiment.

As shown in FIGS. 1A through 1C, an image display apparatus 100 may be a TV. However, it is merely an example, and the image display apparatus 100 may be embodied as any of various electronic apparatuses including displays. For example, the image display apparatus 100 may be embodied as any of various electronic apparatuses including a mobile phone, a tablet personal computer (PC), a digital camera, a camcorder, a laptop computer, a desktop computer, an e-book terminal, a digital broadcast terminal, a personal digital assistant (PDA), a portable multimedia player (PM), a navigation device, a MP3 player, and a wearable device. Furthermore, the image display apparatus 100 may be a stationary apparatus or a mobile apparatus and may be a digital broadcast receiver capable of receiving digital broadcasts.

The image display apparatus 100 may be embodied not only as a flat image display apparatus, but also a curved image display apparatus having a certain curvature or a flexible image display apparatus whose curvature may be adjusted. Output resolutions of the image display apparatus 100 may include high definition (HD) resolution, full HD resolution, ultra HD resolution, or a resolution higher than ultra HD resolution.

The control device 200 may be embodied as any of various types of devices for controlling the image display apparatus 100, e.g., a remote controller or a mobile phone.

Furthermore, the control device 200 may control the image display apparatus 100 via short-distance communication including infrared communication or Bluetooth communication. The control device 200 may control functions of the image display apparatus 100 by using at least one of keys (including buttons), a touchpad, a microphone (not shown) capable of receiving a voice of a user, and a sensor (not shown) capable of recognizing a motion of the control device 200.

The control device 200 may include a power ON/OFF button for turning the image display apparatus 100 ON or OFF. Furthermore, the control device 200 may change a channel of the image display apparatus 100, adjust a volume of the image display apparatus 100, select a ground wave broadcast, a cable broadcast, or a satellite broadcast, or configure a setting.

Furthermore, the control device 200 may be a pointing device. For example, the control device 200 may function as a pointing device when a particular key input is received.

In exemplary embodiments of the present specification, the term “user” refers to a person who controls functions or operations of the image display apparatus 100 by using the control device 200 and may include a viewer, an administrator, or an installation technician.

The image display apparatus 100 according to an exemplary embodiment may display a plurality of items on a display screen. Here, the plurality of items may include items that are displayed in a 2-dimensional (2D) grid format on a display screen. For example, the plurality of items may include an electronic program guide (EPG) including items related to programs that are broadcast in respective channels, images related to news, and icons indicating respective applications, but are not limited thereto.

Referring to FIG. 1A, the image display apparatus 100 may display an EPG that indicates respective broadcast programs with items having lengths corresponding to broadcasting times of the respective broadcast programs. When the image display apparatus 100 displays an EPG, sizes of displayed items may not be identical to one another, because broadcast times of the respective broadcast programs vary. As a result, when the image display apparatus 100 displays an item selected from among the plurality of displayed items with a highlight and moves the highlight according to a user's input, the highlight may not be moved as intended by the user.

For example, as shown in FIG. 1A, when a highlight is located on a particular item 10 and the control device 200 detects a user input for selecting a down key, the image display apparatus 100 may move the highlight to an item 20 or an item 30.

Furthermore, referring to FIG. 1B, the image display apparatus 100 may display a plurality of images indicating news. For example, the image display apparatus 100 may display a plurality of images indicating weather, real-time news, and information in various categories, but the inventive concept is not limited thereto.

The image display apparatus 100 may display an image 40 selected from the plurality of displayed images and move a highlight according to a user input. Respective images indicating news may have different sizes according to displayed information. Therefore, when a highlight is moved in response to a user input, the highlight may not be moved as intended by a user.

Referring to FIG. 1C, the image display apparatus 100 may display icons indicating a plurality of applications. The image display apparatus 100 may display an icon 50 selected from the icons and move a highlight according to a user input. Here, the respective icons may have different sizes according to corresponding applications. Therefore, when a highlight is moved in response to a user input, the highlight may not be moved as intended by a user.

According to a method of displaying an image according to exemplary embodiments, as shown in FIGS. 1A through 1C, in a display apparatus providing a user interface including items that have different sizes and are arranged in a grid format, when a highlight is moved in response to a user input for moving the highlight, the highlight may be moved as intended by a user by selecting an item to which to move the highlight and may be selected by using a reference coordinate.

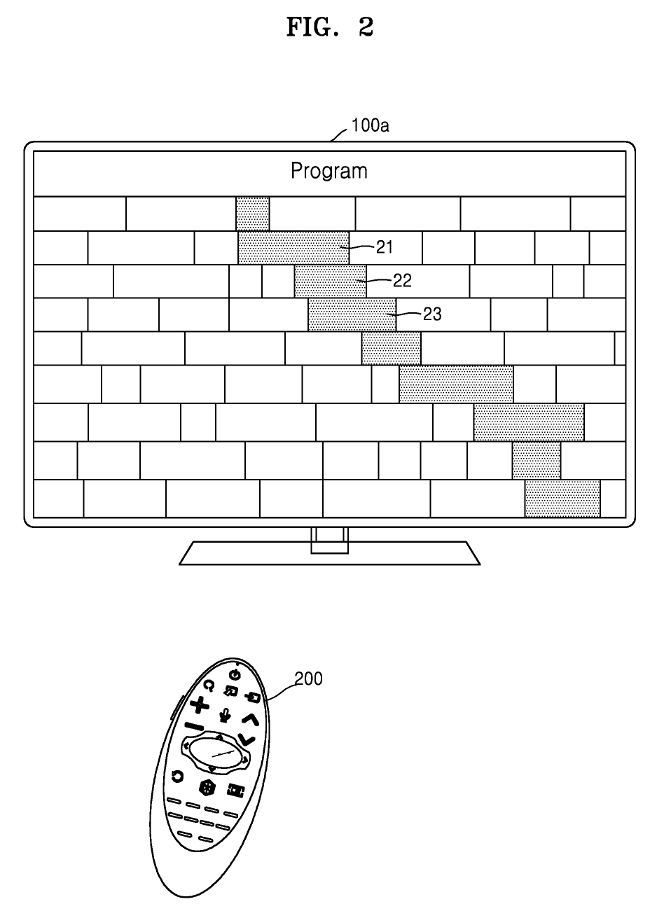

FIG. 2 is a diagram showing an example of moving a highlight based on information regarding an item on which the highlight is currently located.

Referring to FIG. 2, when an image display apparatus 100a detects a user input for selecting a down key of the control device 200 and a highlight may be moved to one of two or more items, the image display apparatus 100a may select the rightmost item.

For example, when a down key input is detected while an item 21 is being displayed with a highlight, the image display apparatus 100a may move the highlight to an item 22. Next, when a down key input is detected again while the item 22 is being displayed with the highlight, the image display apparatus 100a may move the highlight to an item 23. Accordingly, when user inputs for selecting the down key are repeatedly received from the control device 200, the image display apparatus 100a may not move as intended by the a user and may move the highlight in a rightward diagonal direction.

Therefore, there is demand for a technique for moving a highlight as intended by a user based on a detected user input. The inventive concept discloses a method of moving a highlight as intended by a user based on not only a user input and location of an item currently displayed with a highlight, but also a reference coordinate.

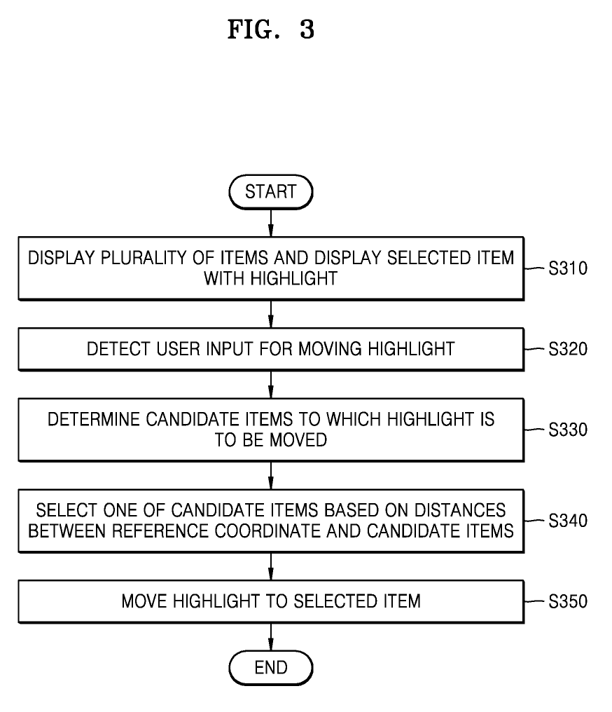

FIG. 3 is a flowchart of a method of displaying an image, according to an exemplary embodiment.

In operation S310, the image display apparatus 100 displays a plurality of items and displays a selected item with a highlight. Here, items may include elements indicating information regarding respective programs in an EPG and images and icons indicating applications, but are not limited thereto.

The image display apparatus 100 may display an item selected from among the plurality of items with a highlight. Here, the term ‘displaying with a highlight’ may include displaying a selected item to be distinguished from the other items by using a color or a borderline but is not limited thereto.

In operation S320, the image display apparatus 100 may detect a user input for moving the highlight. The image display apparatus 100 may detect a user input from the control device 200, such as a remote controller or a mobile phone. Here, the user input may include an input for selecting any one of four direction keys of the control device 200 including an up key, a down key, a left key, and a right key.

In operation S330, the image display apparatus 100 may determine candidate items to which the highlight is to be moved. Here, the candidate items may refer to items adjacent to an item currently displayed with a highlight in a direction in which the highlight moves. For example, if the highlight moves downward, the candidate items may be items adjacent to the bottom of an item currently displayed with a highlight. Therefore, when a plurality of items having different sizes are displayed in an atypical grid-like manner, there may be two or more candidate items.

In operation S340, the image display apparatus 100 may select one of the candidate items based on distances between a reference coordinate and the candidate items. Here, the reference coordinate may be determined based on a location of a first item from which the highlight started to move in a same direction as a current moving direction. For example, the reference coordinate may be a coordinate in a direction perpendicular to the moving direction of the highlight from among coordinates of a first item from which the highlight started to move in a same direction as the current moving direction.

Coordinates of an item may be coordinates of the center point of an area indicating a physical area occupied by the corresponding item in a screen image, but is not limited thereto.

For example, coordinates of an item may be coordinates of the top-left point of an area indicating a physical area occupied by the corresponding item in a screen image. A detailed description thereof will be given below.

Furthermore, candidate items may be items adjacent to an item currently displayed with a highlight in a moving direction of the highlight.

When there are a plurality of candidate items, the image display apparatus 100 may select an item corresponding to the smallest difference between coordinates of the candidate items in a direction perpendicular to the moving direction of the highlight and a reference coordinate.

In operation S350, the image display apparatus 100 may move the highlight to the selected item.

The image display apparatus 100 may move a highlight as intended by a user by selecting one of candidate items based on distances between a reference coordinate and the candidate items.

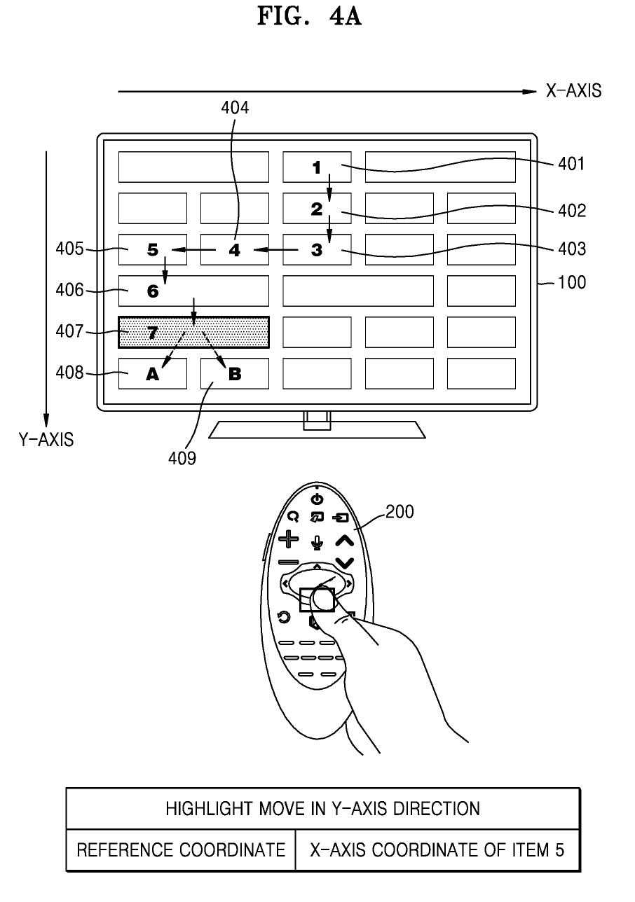

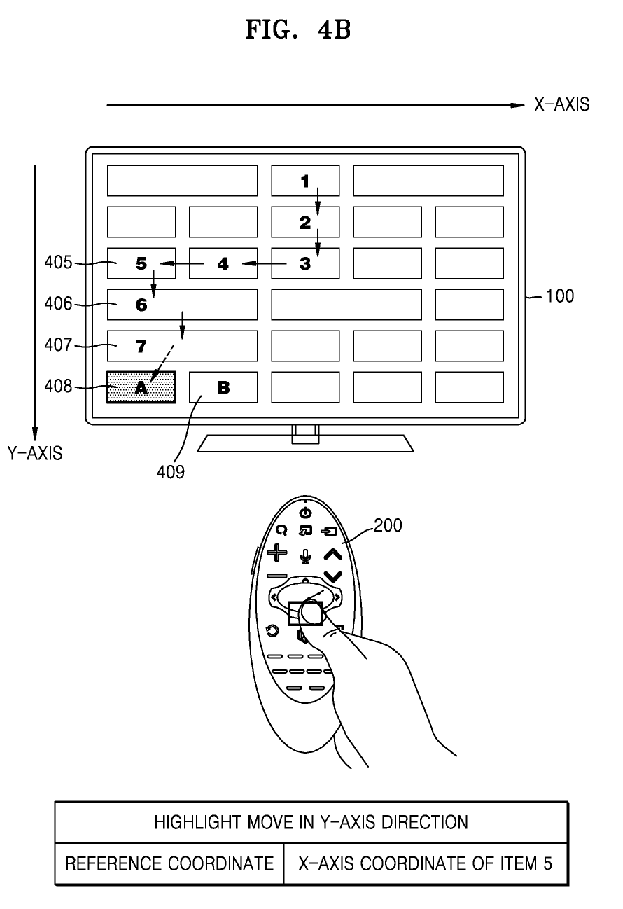

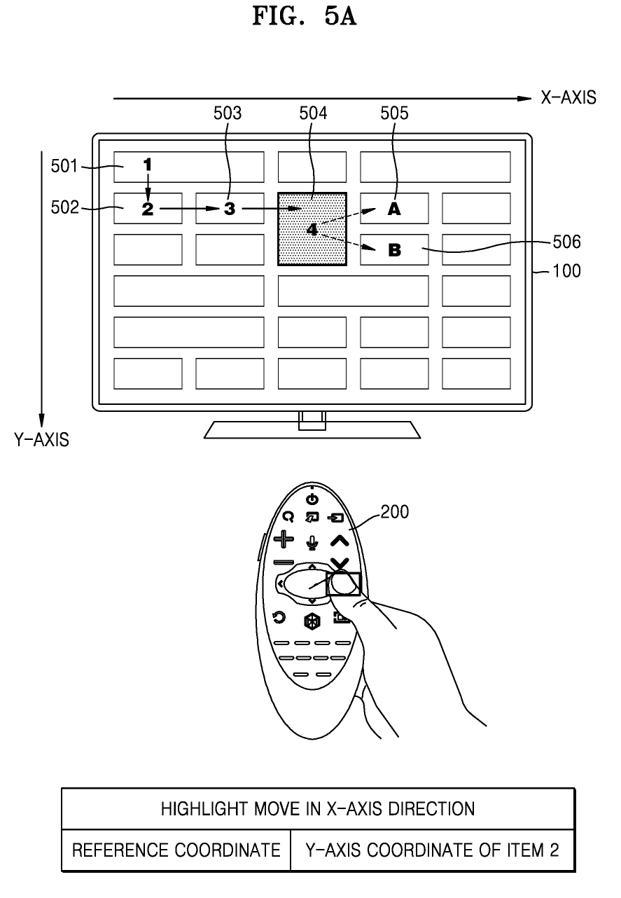

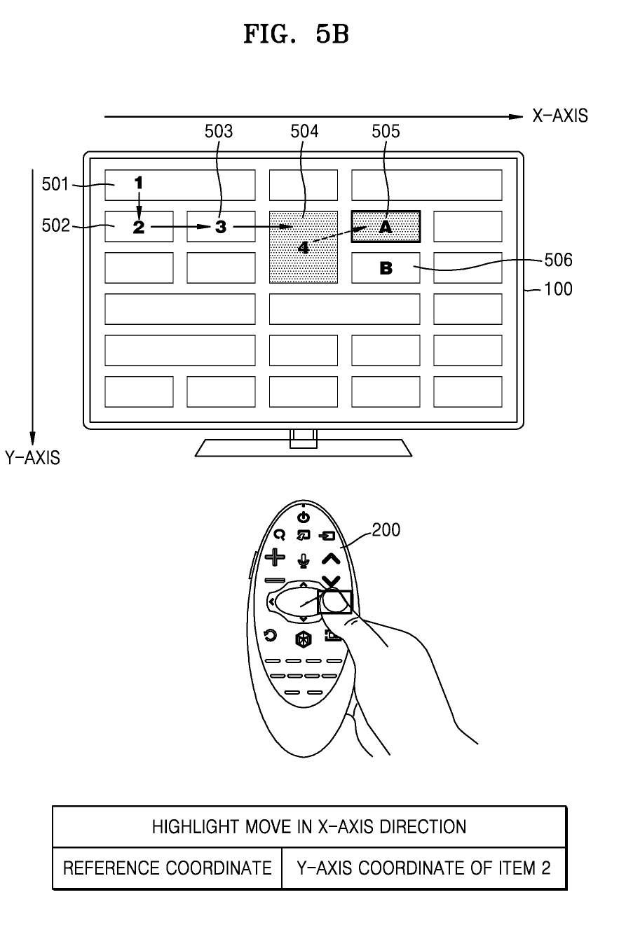

Hereinafter, referring to FIGS. 4A through 5B, a method of displaying an image according to an exemplary embodiment will be described in greater detail.

FIGS. 4A and 4B are diagrams showing an example in which the image display apparatus 100 according to an exemplary embodiment moves a highlight up and down.

For example, as shown in FIG. 4A, according to a user input, a highlight may sequentially pass items 1 401 through 6 406 and be located on a current item 7 407. Next, when a user input corresponding to a downward direction is detected, the image display apparatus 100 may move the highlight in a downward direction from the item 7 407. Here, since the highlight moves in a downward direction, an item A 408 and an item B 409 adjacent to the bottom of the item 7 407 may be candidate items.

The image display apparatus 100 may select one of the candidate items (e.g., the item A 408 and the item B 409) based on a distance between a reference coordinate and the item A 408 and a distance between the reference coordinate and the item B 409.

Here, as described above, the reference coordinate may be determined based on a location of a first item from which the highlight started to move in a same direction as a current moving direction. For example, the reference coordinate may be a coordinate in a direction perpendicular to the moving direction of the highlight from among coordinates of a first item from which the highlight started to move in a same direction as the current moving direction. For example, when the highlight is moving in a y-axis direction, the reference coordinate may be an x-axis coordinate from among coordinates of the first item from which the highlight starts to move in the y-axis direction. For example, referring to FIG. 4A, when the highlight moves from the item 1 401 to an item 3 403, the moving direction of the highlight is a y-axis direction. Here, the reference coordinate may be an x-axis coordinate of a first item (e.g., the item 1 401) from which the highlight starts to move in the y-axis direction.

Next, when the highlight moves from the item 3 403 to the item 5 405, the moving direction of the highlight is an x-axis direction. Here, the reference coordinate may be a y-axis coordinate of a first item (e.g., the item 3 403) from which the highlight starts to move in the x-axis direction.

Furthermore, when the highlight moves from the item 5 405 to the item 7 407, the moving direction of the highlight is a y-axis direction. Here, the reference coordinate may be an x-axis coordinate of the item 5 405. Next, when a user input corresponding to a downward direction is detected, the image display apparatus 100 may select one of the candidate items based on a distance between the reference coordinate and the item A 408 and a distance between the reference coordinate and the item B 409.

Distances between candidate items and a reference coordinate may be determined based on differences between coordinates of the candidate items in a direction perpendicular to a moving direction of the highlight and the reference coordinate. Referring to FIG. 4A, the image display apparatus 100 may calculate differences between x-axis coordinates of the item A 408 and the item B 409 and a reference coordinate (e.g., x-axis coordinate of the item 5 405) and select an item corresponding to the smallest difference.

Therefore, as shown in FIG. 4B, the image display apparatus 100 may move the highlight to the item A 408.

Meanwhile, when differences between candidate items and a reference coordinate are identical to one another, the image display apparatus 100 may select the leftmost item or the rightmost item from among the candidate items. However, criteria for selecting an item may vary according to settings. Therefore, when differences between candidate items and a reference coordinate are identical to one another, the image display apparatus 100 may select the rightmost item or the lowermost item from among candidate items.

FIGS. 5A and 5B are diagrams showing an example in which the image display apparatus 100 according to an exemplary embodiment moves a highlight left/right.

For example, as shown in FIG. 5A, a highlight may be moved from an item 1 501 to an item 2 502 according to a user input. Here, since the highlight moves in a y-axis direction, a reference coordinate may be an x-axis coordinate of a first item (e.g., the item 1 501) from which the highlight starts to move in the y-axis direction.

Next, when the highlight moves from the item 2 502 to an item 3 503, the moving direction of the highlight is an x-axis direction. Here, a reference coordinate may be a y-axis coordinate of a first item (e.g., the item 2 502) from which the highlight starts to move in the x-axis direction. While the highlight is moving from the item 2 502 to an item 4 504, the highlight continues to move in the x-axis direction, and thus the y-axis coordinate of the item 2 502 may be maintained as the reference coordinate.

Next, when a user input corresponding to a rightward direction is detected, the image display apparatus 100 may move the highlight in a rightward direction from the item 4 504. Since the highlight moves in the rightward direction, candidate items may be an item A 505 and an item B 506 adjacent to the right end of the item 4 504.

The image display apparatus 100 may select one of the candidate items (e.g., the item A 505 and the item B 506) based on distances between the candidate items and a reference coordinate.

Referring to FIG. 5A, the image display apparatus 100 may calculate a difference between the y-axis coordinate of the item A 505 and the y-axis coordinate of the item 2 502 and a difference between the y-axis coordinate of the item B 506 and the y-axis coordinate of the item 2 502 and move a highlight to an item corresponding to a smaller difference.

Accordingly, the image display apparatus 100 may move a highlight to the item A 505 as shown in FIG. 5B.

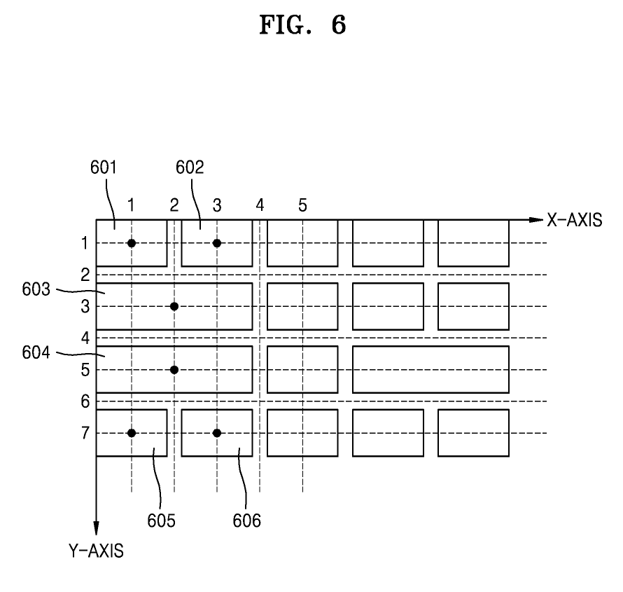

FIG. 6 is a diagram for describing a method of indicating coordinates of an item on an image display apparatus according to an exemplary embodiment.

As described above, the image display apparatus 100 may select one of candidate items based on distances between a reference coordinate and the candidate items. Here, the distances between the reference coordinate and the candidate items may be calculated by using coordinates of the candidate items.

As shown in FIG. 6, when a plurality of items are displayed in a screen image, the image display apparatus 100 may indicate coordinates of each item with an x-axis coordinate and a y-axis coordinate. Here, coordinates of an item may be coordinates of the center point of an area indicating a physical area occupied by the item in the screen image.

For example, referring to FIG. 6, coordinates of the point at which the x-axis and the y-axis intersect each other may be indicated as (0, 0). Furthermore, coordinates of an item 601 may be indicated as (1, 1), coordinates of an item 602 may be indicated as (3, 1), coordinates of an item 603 may be indicated as (2, 3), coordinates of an item 604 may be indicated as (2, 5), coordinates of an item 605 may be indicated as (1, 7), and coordinates of an item 606 may be indicated as (3, 7).

Furthermore, coordinates of an item may be coordinates of the top-left point of an area indicating a physical area occupied by each item in a screen image, but the inventive concept is not limited thereto.

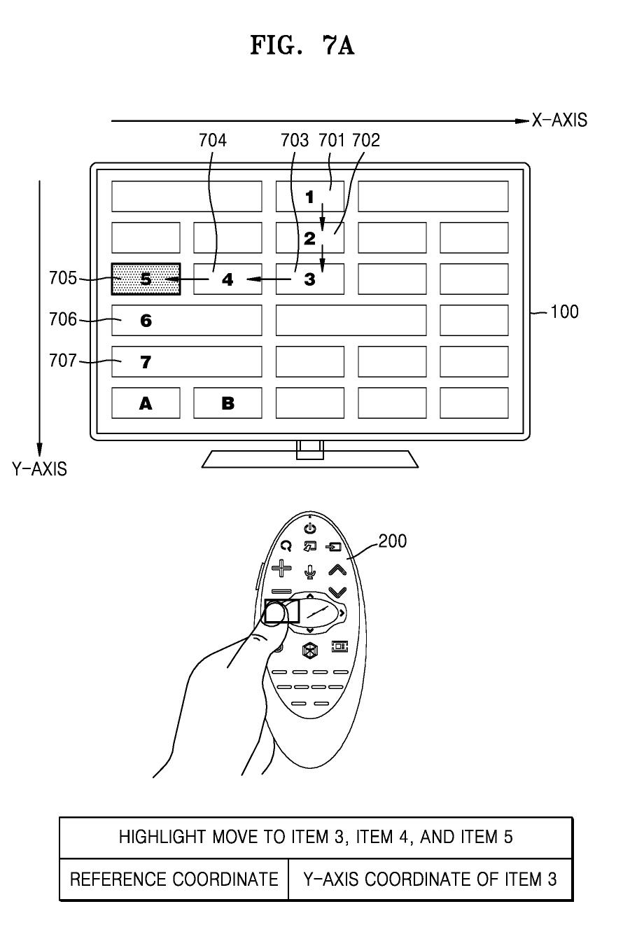

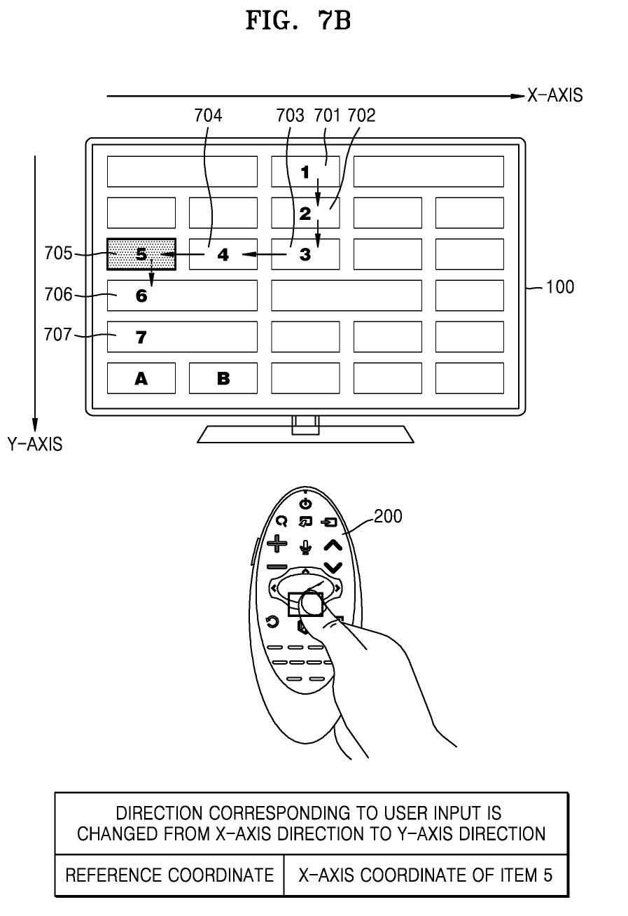

FIGS. 7A and 7B are diagrams for describing a case where a direction of a user input is changed in an image display apparatus according to an exemplary embodiment.

Referring to FIG. 7A, a highlight may be moved from an item 1 701 to an item 3 703, may be moved from the item 3 703 to an item 5 705, and may be located on a current item 5 705. While the highlight is being moved from the item 3 703 to the item 5 705, a direction in which the highlight is moved is an x-axis direction, and a reference coordinate may be indicated as y-axis coordinate of a first item (e.g., the item 3 703) from which the highlight starts to be moved in the x-axis direction.

However, as shown in FIG. 7B, if a direction corresponding to a user input is changed to a direction perpendicular to the x-axis direction, the image display apparatus 100 may update the reference coordinate. For example, as a direction corresponding to a user input is changed from the x-axis direction to a y-axis direction, the reference coordinate may be updated to a first item (e.g., the item 5 705) from which the highlight starts to be moved in the y-axis direction.

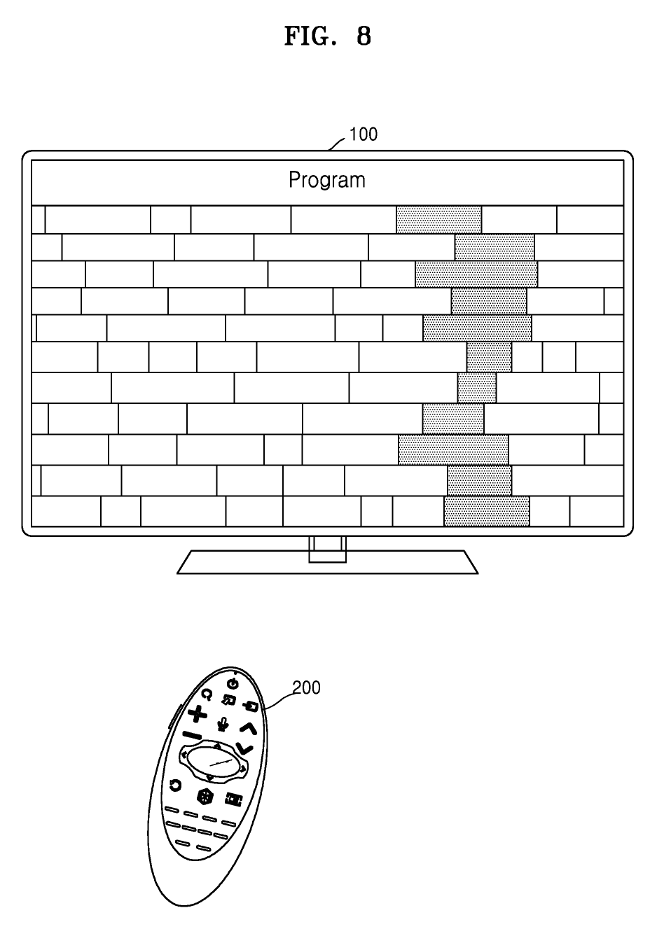

FIG. 8 is a diagram showing an example of a method of displaying an image according to an exemplary embodiment.

According to the method of displaying an image according to an exemplary embodiment, a highlight may be moved based on distances between a reference coordinate and candidate items. Therefore, the image display apparatus 100 may reduce unnecessary operations for moving a highlight to a location desired by a user. Furthermore, even when a plurality of items are displayed in a 2D atypical grid-like format, the image display apparatus 100 may move a highlight as desired by a user.

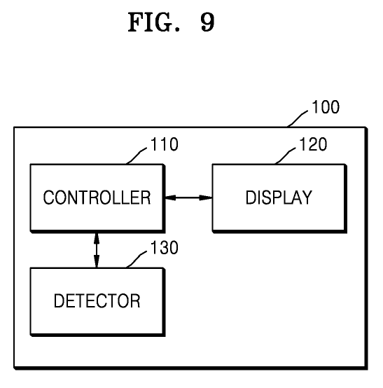

FIG. 9 is a block diagram showing configuration of the image display apparatus 100 according to an exemplary embodiment.

Referring to FIG. 9, the image display apparatus 100 may include a controller 110, a display 120, and a detector 130. However, not all of the components shown in FIG. 8 are necessary. The image display apparatus 100 may include less or more components that the components shown in FIG. 9.

Hereinafter, detailed description of the components will be given.

The display 120 may display a plurality of items and highlight an item selected from among the plurality of items. Displayed items may include an electronic program guide (EPG) including items related to programs that are broadcasted in respective channels, images related to news, and icons indicating respective applications, but are not limited thereto.

Furthermore, the display 120 may display a plurality of items in a 2D grid. Here, the items may be displayed in rectangular shapes as shown in FIGS. 4A through 8. However, the inventive concept is not limited thereto.

The detector 130 may detect a user input for moving a highlight. Here, the detector 130 may detect a user input from the control device 200, such as a remote controller or a mobile phone. However, the inventive concept is not limited thereto. The user input may be an input corresponding to any one of four directions including up, down, left, and right.

The controller 110 may decide candidate items to which a highlight is to be moved in response to a detected user input. Here, the candidate items to which a highlight is to be moved may be items adjacent to an item currently displayed with a highlight in a direction in which the highlight is to be moved. For example, if the direction in which the highlight is to be moved is a downward direction, the candidate items may be items adjacent to the bottom of the item currently displayed with the highlight.

Furthermore, the controller 110 may select one of candidate items based on distances between a reference coordinate and the candidate items. Here, the reference coordinate may be a coordinate in a direction perpendicular to a moving direction of the highlight from among coordinates of a first item from which a highlight starts to move in a direction identical to the current moving direction.

Therefore, the controller 110 may select an item corresponding to the smallest difference between coordinates of the candidate items in the direction perpendicular to the moving direction of the highlight and the reference coordinate.

Furthermore, when distances between the reference coordinate and the candidate items are identical to one another, the controller 110 may select the leftmost item or the topmost item from among the candidate items. However, the inventive concept is not limited thereto. Therefore, when changes of location of a highlight regarding candidate items are identical to one another, an item selected from among the candidate items may differ based on settings.

As a direction corresponding to the user input is switched to a direction perpendicular to the current moving direction of the highlight, the controller 110 may update the reference coordinate based on coordinates of the item currently being displayed with the highlight. Here, the controller 110 may update the reference coordinate with a coordinate of the item currently being displayed with the highlight in a direction perpendicular to the direction corresponding to the user input from among coordinates of the item currently being displayed with the highlight.

The controller 110 may move the highlight to the item selected from among the candidate items.

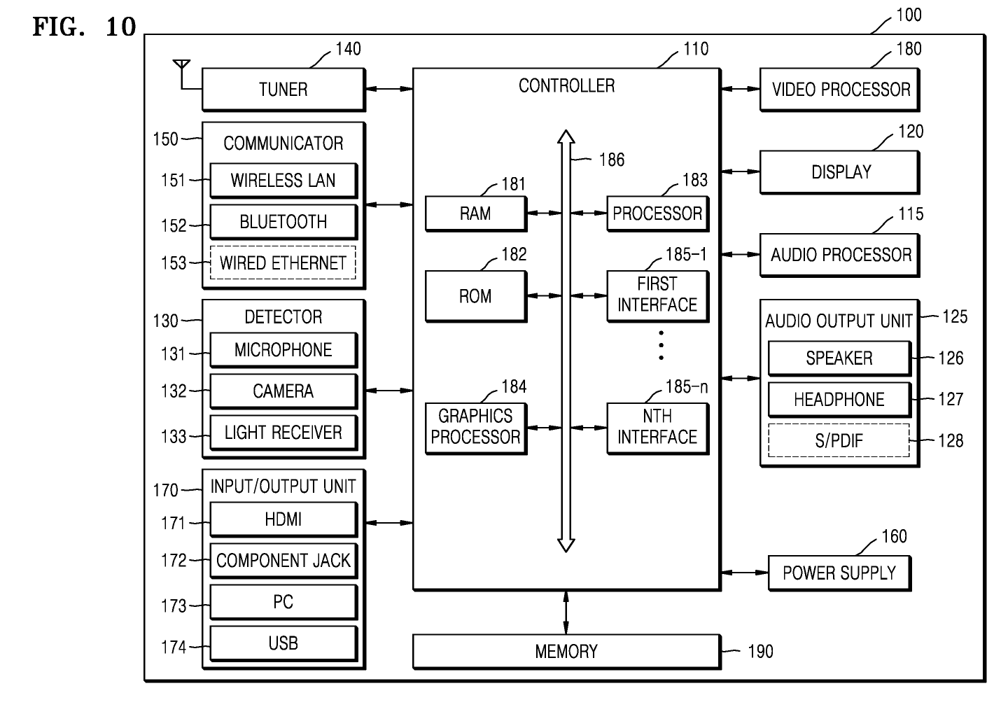

FIG. 10 is a block diagram showing configuration of an image display apparatus 100 according to another exemplary embodiment.

As shown in FIG. 10, the image display apparatus 100 may include the controller 110, the display 120, and the detector 130 and may further include a video processor 180, an audio processor 115, an audio output unit 125, a power supply 160, a tuner 140, a communicator 150, an input/output unit 170, and a storage 190.

Descriptions of the controller 110, the display 120, and the detector 130 identical to those given above with reference to FIG. 9 will be omitted below.

The video processor 180 processes video data received by the image display apparatus 100. The video processor 180 may perform various image processing operations with regard to video data, such as decoding, scaling, noise filtering, frame rate conversion, and resolution conversion.

The displays a video included in a broadcasting signal received via the tuner 140 under the control of the controller 110. Furthermore, the display 120 may display content (e.g., moving pictures) input via the communicator 150 or the input/output unit 170. The display 120 may output an image stored in the memory 190 under the control of the display 120. Furthermore, the display 120 may display a voice user interface (UI) (e.g., a UI including a voice command guide) for performing a voice recognition task or a motion UI (e.g., a UI including a user motion guide for motion recognition) for performing a motion recognition task.

The audio processor 115 processes audio data. The audio processor 115 may perform various audio processing operations including decoding, amplification, and noise filtering with regard to audio data. Meanwhile, the audio processor 115 may include a plurality of audio processing modules for processing audio data corresponding to a plurality of contents.

The audio output unit 125 outputs an audio included in a broadcasting signal received via the tuner 140 under the control of the tuner 140. Furthermore, the audio output unit 125 may output an audio (e.g., a voice, a sound) input via the communicator 150 or the input/output unit 170. Furthermore, the audio output unit 125 may output an audio stored in the memory 190 under the control of the controller 110. The audio output unit 125 may include at least one of a speaker 126, a headphone output terminal 127, and a Sony/Philips digital interface (S/PDIF) output terminal 128. The audio output unit 125 may include a combination of the speaker 126, the headphone output terminal 127, and the S/PDIF output terminal 128.

The power supply 160 supplies power input from an external power source to internal components of the image display apparatus 100 under the control of the controller 110. Furthermore, the detector 130 may supply power output by one, two, or more batteries (not shown) arranged in the image display apparatus 100 to the internal components of the image display apparatus 100 under the control of the controller 110

The tuner 140 may tune and select frequency corresponding to a channel to be received by the image display apparatus 100 from among a large number of frequency ingredients in a broadcasting signal that is received via a wire or wirelessly by amplifying, mixing, and resonating the broadcasting signal. Here, a broadcasting signal includes an audio data signal, a video signal, and additional information (e.g., electronic program guide (EPG)).

The tuner 140 may receive a broadcasting signal in a frequency band corresponding to a channel number (e.g., a cable broadcast No. 506) based on a user input (e.g., a control signal received from the control device 200, such as a channel number input, a channel up-down input, and a channel input on an EPG screen image).

The tuner 140 may receive a broadcasting signal from various sources, such as a ground wave broadcasting service, a cable broadcasting service, a satellite broadcasting service, and an internet broadcasting service. The tuner 140 may receive a broadcasting signal from sources like an analog broadcasting service or a digital broadcasting service. A broadcasting signal received by the tuner 140 is decoded (e.g., audio decoding, video decoding, or additional information decoding) and is split to an audio signal, a video signal, and/or additional information. The audio signal, the video signal, and/or the additional information obtained from the broadcasting signal may be stored in the memory 190 under the control of the controller 110.

The image display apparatus 100 may include one tuner 140 or a plurality of tuners 140. The tuner 140 may be integrated with the image display apparatus 100, may be embodied as an independent device (e.g., a set-top box (not shown)) having a tuner electrically connected to the image display apparatus 100, or may be embodied as a tuner connected to the input/output unit 170.

The communicator 150 may connect the image display apparatus 100 to an external device (e.g., an audio device) under the control of the controller 110. The controller 110 may transmit/receive content to/from an external device connected thereto, download an application from the external device, or browse web pages, via the communicator 150.

Based on performance and structure of the image display apparatus 100, the communicator 150 may include one of a wireless LAN module 151, a Bluetooth module 152, and a wire Ethernet module 153. Furthermore, the communicator 150 may include a combination of the wireless LAN module 151, the Bluetooth module 152, and the wire Ethernet module 153. The communicator 150 may receive a control signal of the control device 200 under the control of the controller 110. A control signal may be embodied as a Bluetooth signal, a RF signal, or a Wi-Fi signal.

For example, the communicator 150 may receive a Bluetooth signal corresponding to a user input (e.g., a touch, a press, a touch gesture, a voice, or a motion) from the control device 200 via the Bluetooth module 152.

The communicator 150 may include short-range wireless communication modules other than the Bluetooth module 152, e.g., a near field communication (NFC) module (not shown), a Bluetooth low energy (BLE) module, etc.

The detector 130 detects a voice of a user, an image of the user, or an interaction of the user.

The microphone 131 receives a voice uttered by a user. The microphone 131 may transform a received voice into an electric signal and output the electric signal to the controller 110. A user's voice may include a voice corresponding to a menu or a function of the image display apparatus 100. A voice recognition range of the microphone 131 may be within a distance about 4 meters from the microphone 131, where the voice recognition range of the microphone 131 may vary based on the volume of a voice of a user and surrounding environmental conditions (e.g., a volume of a speaker, ambient noise, etc.).

According to an exemplary embodiment, for the controller 110 to recognize the identity of a user watching the image display apparatus 100, the microphone 131 may receive a voice uttered by the user and output received voice data to the controller 110.

The microphone 131 may be integrated with the image display apparatus 100 or may be embodied as an independent device. The independent microphone 131 may be connected to the image display apparatus 100 via the communicator 150 or the input/output unit 170.

It would be obvious to one of ordinary skill in the art that the microphone 131 may be omitted according to performances and structures of the image display apparatus 100.

The camera 132 receives an image (e.g., successive frames) corresponding to a user's motion including a gesture within a recognition range of the camera 132. For example, the recognition range of the camera 132 may be within a distance from about 0.1 m to about 5 m from the camera 162. A user's motion may include a motion of a body part of the user, e.g., a face, a face expression, a hand, a fist, a finger, etc. The camera 132 may transform a received image into an electric signal and output the electric signal to the controller 110, under the control of the controller 110.

According to an exemplary embodiment, for the controller 110 to recognize the identity of a user watching the image display apparatus 100, the camera 132 may capture a face image of a user and output the captured face image to the controller 110.

The controller 110 may select a menu displayed on the image display apparatus 100 by using a result of recognizing a received motion or perform a task corresponding to the result of the motion recognition, e.g., changing channel, adjusting volume, moving a cursor, etc.

The camera 132 may include a lens (not shown) and an image sensor (not shown). The camera 132 may provide optical zoom or digital zoom by using a plurality of lenses and image processing techniques. The recognition range of the camera 132 may vary according to angles of the camera 132 and surrounding environmental conditions. If the camera 132 consists of a plurality of cameras, a 3-dimensional (3D) still image or a 3D motion may be received by using the plurality of cameras.

The camera 132 may be integrated with the image display apparatus 100 or may be embodied as an independent device. An independent device (not shown) including the camera 132 may be electrically connected to the image display apparatus 100 via the communicator 150 or the input/output unit 170.

It would be obvious to one of ordinary skill in the art that the camera 132 may be omitted according to performances and structures of the image display apparatus 100.

The light receiver 133 receives an optical signal (including a control signal) from the external control device 200 via an optical window (not shown) of the bezel of the display 120. The light receiver 133 may receive an optical signal corresponding to a user input (e.g., a touch, a press, a touch gesture, a voice, or a motion) from the control device 200. A control signal may be extracted from the received optical signal under the control of the controller 110.

According to exemplary embodiments, the optical receiver 133 may receive an optical signal indicating that any one of keys of the control device 200 corresponding to two directions or four directions is selected and transmit the received optical signal to the controller 110.

The input/output unit 170 receives a video (e.g., moving pictures, etc.), an audio (e.g., voice, music, etc.), and additional information (e.g., an EPG, etc.) from outside of the image display apparatus 100 under the control of the controller 110. The input/output unit 170 may include at least one of a high-definition multimedia interface port 171, a component jack 172, a PC port 173, and a USB port 174. The input/output unit 170 may include a combination of the HDMI port 171, the component jack 172, the PC port 173, and the USB port 174.

It would be obvious to one of ordinary skill in the art that configurations and operations of the input/output unit 170 may vary according to exemplary embodiments of the inventive concept.

The controller 110 controls the overall operations of the image display apparatus 100, controls signal flows between internal components of the image display apparatus 100, and processes data. When a user input is applied or a certain condition is satisfied, the controller 110 may execute an operating system (OS) and various applications stored in the memory 190.

The controller 110 may store a signal or data received from outside of the image display apparatus 100. Furthermore, the controller 110 may include a RAM 181 that is used as a storage area corresponding to various tasks performed by the image display apparatus 100, a ROM 182 having stored therein control programs for controlling the image display apparatus 100, and a processor 183.

The processor 183 may include a graphics processing unit (GPU) (not shown) for processing graphics data corresponding to a video. The processor 183 may be embodied as a system-on-chip (SoC) having integrated thereon a core (not shown) and a GPU (not shown). The processor 183 may include a single core, dual cores, triple cores, quad cores, and cores in multiples of 4. Furthermore, the processor 183 may include a plurality of processors. For example, the processor 183 may include a main processor (not shown) and a sub processor (not shown) that operates in a sleep mode.

A graphics processor 184 generates a screen image including various objects, such as icons, images, and texts, by using a processor (not shown) and a renderer (not shown). The processor calculates property values, such as coordinate values, shapes, sizes, and colors, for displaying respective objects according to a layout of a screen image by using a user input detected by the detector 130. The renderer generates screen images having various layouts including objects based on property values calculated by the processor. A screen image generated by the renderer is displayed within a display area of the display 120.

First through nth interfaces 185-1 through 185-n are connected to the above-stated components. One of the first through nth interfaces 185-1 through 185-n may be a network interface that is connected to an external device via a network.

The RAM 181, the ROM 182, the processor 183, the graphics processor 184, and the first through nth interfaces 185-1 through 185-n may be connected to one another via an internal bus 186.

In the present exemplary embodiment, the term ‘control unit’ includes the processor 183, the ROM 182, and the RAM 181.

The memory 190 may store various data, programs, or applications for operating and controlling the image display apparatus 100 under the control of the controller 110. Furthermore, the storage 190 may store a reference coordinate under the control of the controller 110.

The memory 190 may store signals or data input/output in correspondence to operations of the video processor 180, the display 120, the audio processor 115, the audio output unit 125, the detector 130, the tuner 140, the communicator 150, the detector 130, and the input/output unit 170. The memory 190 may store control programs for controlling the image display apparatus 100 and the controller 110, applications initially provided by a manufacturer of the image display apparatus 100 or downloaded from outside, graphical user interfaces (GUI) related to the applications, objects (e.g., images, texts, icons, buttons, etc.) for providing the GUIs, user information, documents, databases, or data related thereto.

According to an exemplary embodiment, the term “memory” includes the memory 190, the ROM 182 and the RAM 181 of the controller 110, and/or a memory card (not shown) attached to the image display apparatus 100 (e.g., a micro SD card, a USB memory, etc.). Furthermore, the memory 190 may include a non-volatile memory, a volatile memory, a hard disk drive (HDD), or a solid state disk (SSD).

Although not shown, the memory 190 may include a broadcast receiving module, a channel control module, a volume control module, a communication control module, a voice recognition module, a motion recognition module, an optical receiving module, a display control module, an audio control module, an external input control module, a power control module, a module for controlling a wirelessly connected external device (e.g., connected via a Bluetooth communication), a voice database (DB), or a motion DB. The modules (not shown) and the DB (not shown) of the memory 190 may be embodied in the form of software for controlling the image display apparatus 100 to perform a broadcast reception control function, a channel control function, a volume control function, a communication control function, a voice recognition function, a motion recognition function, an optical reception control function, a display control function, an audio control function, an external input control function, a power control function, or a function for controlling a wirelessly connected external device (e.g., connected via a Bluetooth communication). The controller 110 may perform the above-stated functions by using the software modules stored in the memory 190.

Furthermore, according to exemplary embodiments, the storage 190 may include a module including one or more instructions for determining candidate items to which a highlight is to be moved in response to a user input for moving the highlight, selecting one of the candidate items based on distances between a reference coordinate and the candidate items, and moving the highlight to the selected item.

Furthermore, the image display apparatus 100 including the display 120 may be electrically connected to an independent external device including the tuner 140 (e.g., a set-top box) (not shown). For example, the image display apparatus 100 may be embodied as an analog TV, a digital TV, a 3D TV, a smart TV, a LED TV, an OLED TV, a plasma TV, or a monitor. However, it would be obvious to one of ordinary skill in the art that the inventive concept is not limited thereto.

The image display apparatus 100 may include a sensor (not shown) for detecting a condition inside or outside the image display apparatus 100 (e.g., an illuminance sensor, a temperature sensor, etc.).

Meanwhile, the image display apparatuses 100 shown in FIGS. 9 and 10 are merely embodiments. The components shown in FIGS. 9 and 10 may be integrated with one another, additional components may be introduced, or some of the components shown in FIGS. 2 and 3 may be omitted according to specifications of the image display apparatus 100. In other words, as occasion demands, two or more components may be integrated as a single component or a single component may be split to two or more components. Furthermore, functions performed by respective blocks are merely for describing exemplary embodiments, and operations and devices related thereto do not limit the inventive concept.

The above-described exemplary embodiments of the inventive concept may be implemented as programmable instructions executable by a variety of computer components and stored in a non-transitory computer readable recording medium. The non-transitory computer readable recording medium may include program instructions, a data file, a data structure, or any combination thereof. The program instructions stored in the non-transitory computer readable recording medium may be designed and configured specifically for the inventive concept or can be publicly known and available to those of ordinary skill in the field of software. Examples of the non-transitory computer readable recording medium include a hardware device specially configured to store and perform program instructions, for example, a magnetic medium, such as a hard disk, a floppy disk, and a magnetic tape, an optical recording medium, such as a CD-ROM, a DVD, and the like, a magneto-optical medium, such as a floptical disc, a ROM, a RAM, a flash memory, and the like. Examples of the program instructions include machine codes made by, for example, a compiler, as well as high-level language codes executable by a computer using an interpreter.

It should be understood that exemplary embodiments described herein should be considered in a descriptive sense only and not for purposes of limitation. Descriptions of features or aspects within each embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. An image display apparatus comprising:
a display configured to display a plurality of items and displays an item selected from among the plurality of items with a highlight;
a detector configured to detect a user input for moving the highlight; and
a controller configured to, in response to the user input, determines candidate items to which the highlight is to be moved, select one of the candidate items based on distances between a reference coordinate and the candidate items, and move the highlight to the selected item.

2. The image display apparatus of claim 1, wherein the reference coordinate is determined based on a location of a first item from which the highlight starts to move in a direction identical to a current moving direction of the highlight.

3. The image display apparatus of claim 2, wherein the reference coordinate is a coordinate in a direction perpendicular to the moving direction of the highlight from among coordinates of the first item.

4. The image display apparatus of claim 3, wherein the controller is further configured to select an item corresponding to the smallest difference between coordinates of the candidate items in the direction perpendicular to the moving direction of the highlight and the reference coordinate.

5. The image display apparatus of claim 1, wherein, when distances between the reference coordinate and the candidate items are identical to one another, the controller is further configured to select a leftmost item or a topmost item from among the candidate items.

6. The image display apparatus of claim 1, wherein the candidate items are items adjacent to the item currently being displayed with the highlight in a current moving direction of the highlight.

7. The image display apparatus of claim 6, wherein, as a direction corresponding to the user input is changed to a direction perpendicular to the current moving direction of the highlight, the controller is further configured to update the reference coordinate based on coordinates of the item currently being displayed with the highlight.

8. The image display apparatus of claim 7, wherein the controller is further configured to update the reference coordinate with a coordinate in a direction perpendicular to the direction corresponding to the user input from among coordinates of the item currently being displayed with the highlight.

9. The image display apparatus of claim 1, wherein the display is further configured to display the plurality of items in a 2-dimensional (2D) grid format.

10. The image display apparatus of claim 1, wherein the detector is further configured to detect a user input for moving the highlight in any one of directions including up, down, left, and right.

11. A method of displaying an image, the method comprising:
displaying a plurality of items and displaying an item selected from among the plurality of items with a highlight;
detecting a user input for moving the highlight;
determining candidate items to which the highlight is to be moved, in response to the user input;
selecting one of the candidate items based on distances between a reference coordinate and the candidate items; and
moving the highlight to the selected item.

12. The method of claim 11, wherein the reference coordinate is determined based on a location of a first item from which the highlight starts to move in a direction identical to a current moving direction of the highlight.

13. The method of claim 12, wherein the reference coordinate is a coordinate in a direction perpendicular to the moving direction of the highlight from among coordinates of the first item.

14. The method of claim 13, wherein the selecting of one of the candidate items comprises selecting an item corresponding to the smallest difference between coordinates of the candidate items in the direction perpendicular to the moving direction of the highlight and the reference coordinate.

15. The method of claim 11, wherein the selecting of one of the candidate items further comprises, when distances between the reference coordinate and the candidate items are identical to one another, selecting a leftmost item or a topmost item from among the candidate items.

16. The method of claim 11, wherein the candidate items are items adjacent to the item currently being displayed with the highlight in a current moving direction of the highlight.

17. The method of claim 16, further comprising, as a direction corresponding to the user input is changed to a direction perpendicular to the current moving direction of the highlight, updating the reference coordinate based on coordinates of the item currently being displayed with the highlight,
wherein the updated reference coordinate is a coordinate of the item currently being displayed with the highlight in a direction perpendicular to the direction corresponding to the user input from among coordinates of the item currently being displayed with the highlight.

18. The method of claim 11, wherein the displaying of the plurality of items comprises displaying the plurality of items in a 2-dimensional (2D) grid format.

19. The method of claim 11, wherein the detecting of the user input comprises detecting a user input for moving the highlight in any one of directions including up, down, left, and right.

20. A non-transitory computer readable recording medium having recorded thereon a computer program for implementing the method of claim 11.
